(19) United States
(12) Patent Application Publication
(10) Pub. No.: US 2026/0200455 A1
(43) Pub. Date: Jul. 16, 2026

(54) VEHICLE DRIVING CONTROL DEVICE

(71) Applicant: SUBARU CORPORATION, Tokyo (JP)

(72) Inventor: Harunobu HORIGUCHI, Tokyo (JP)

(21) Appl. No.: 19/436,868

(22) Filed: Dec. 30, 2025

(30) Foreign Application Priority Data
Jan. 10, 2025 (JP) 2025-003854

(51) Int. Cl. B60W 10/14; B60W 40/10

(52) U.S. Cl. CPC B60W 10/14; B60W 40/10; B60W 2300/18; B60W 2520/10; B60W 2520/263; B60W 2520/28

(57) ABSTRACT

A vehicle driving control device includes a wheel speed detector that detects wheel speeds of front and rear wheels of a four-wheel-drive vehicle, and a tire chain mounting determination logic unit. The logic unit includes: a vehicle body speed detector; a front wheel slip ratio calculator that calculates a front wheel slip ratio based on the front wheel speeds and vehicle body speed; a rear wheel slip ratio calculator that calculates a rear wheel slip ratio based on the rear wheel speeds and vehicle body speed at a same road surface position as that at which the front wheel slip ratio has been calculated; and a tire chain mounting determiner that determines that tire chains are mounted on the front wheels or the rear wheels which have a lower slip ratio when a difference between the front and rear slip ratios is greater than or equal to a first threshold.

### CROSS-REFERENCE TO RELATED APPLICATIONS

The present application claims priority from Japanese Patent Application No. 2025-003854 filed on Jan. 10, 2025, the entire contents of which are hereby incorporated by reference.

### BACKGROUND

The disclosure relates to a vehicle driving control device.

In a four-wheel-drive vehicle, when tire chains are mounted on the front or rear wheels, a significant difference in grip force arises between the wheels equipped with the tire chains and those without. Therefore, it is preferable to appropriately modify driving controls, such as front/rear drive torque distribution control and vehicle dynamics control, after the tire chains are mounted.

When attempting to automatically modify driving control after tire chains are mounted, firstly the control unit automatically detects whether the tire chains are mounted.

For example, Japanese Unexamined Patent Application Publication (JP-A) No. 2019-113940 discloses a technique in which the frequency characteristics due to vertical vibrations generated in the vehicle are compared with past frequency characteristics, and if the frequency characteristics differ, it is determined that the vehicle is equipped with tire chains.

### SUMMARY

An aspect of the disclosure provides a vehicle driving control device including a wheel speed detector and a tire chain mounting determination logic unit. The wheel speed detector is configured to detect respective wheel speeds of front wheels and rear wheels of a four-wheel-drive vehicle. The tire chain mounting determination logic unit includes a vehicle body speed detector, a front wheel slip ratio calculator, a rear wheel slip ratio calculator, and a tire chain mounting determiner. The vehicle body speed detector is configured to detect a vehicle body speed of the four-wheel-drive vehicle. The front wheel slip ratio calculator is configured to calculate a front wheel slip ratio based on the wheel speeds of the front wheels detected by the wheel speed detector and the vehicle body speed detected by the vehicle body speed detector. The rear wheel slip ratio calculator is configured to calculate a rear wheel slip ratio based on the wheel speeds of the rear wheels detected by the wheel speed detector and the vehicle body speed detected by the vehicle body speed detector, at a same road surface position as a road surface position at which the front wheel slip ratio has been calculated. The tire chain mounting determiner is configured to determine that tire chains are mounted on the front wheels or the rear wheels which have a lower slip ratio when a difference between the front wheel slip ratio calculated by the front wheel slip ratio calculator and the rear wheel slip ratio calculated by the rear wheel slip ratio calculator is greater than or equal to a first threshold.

An aspect of the disclosure provides a vehicle driving control device including a wheel speed detector and circuitry. The wheel speed detector includes a sensor and is configured to detect respective wheel speeds of front wheels and rear wheels of a four-wheel-drive vehicle. The circuitry is configured to: detect a vehicle body speed of the four-wheel-drive vehicle; calculate a front wheel slip ratio based on the wheel speeds of the front wheels detected by the wheel speed detector and the vehicle body speed; calculate a rear wheel slip ratio based on the wheel speeds of the rear wheels detected by the wheel speed detector and the vehicle body speed, at a same road surface position as a road surface position at which the front wheel slip ratio has been calculated; and determine that tire chains are mounted on the front wheels or the rear wheels which have a lower slip ratio when a difference between the front wheel slip ratio calculated by the front wheel slip ratio calculator and the rear wheel slip ratio calculated by the rear wheel slip ratio calculator is greater than or equal to a first threshold.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a configuration diagram of a vehicle driving control device according to an embodiment;

FIG. 2A is a flowchart (part 1) illustrating a tire chain mounting determination routine;

FIG. 2B is a flowchart (part 2) illustrating the tire chain mounting determination routine;

FIG. 3A is an explanatory diagram illustrating a state in which the slip ratio of the front wheels is calculated at a determination position on a low-μ road;

FIG. 3B is an explanatory diagram illustrating a state in which the slip ratio of the rear wheels is calculated at the determination position on the low-μ road;

FIG. 4A is an explanatory diagram illustrating a state in which the slip ratio of the front wheels is calculated at a determination position on a road surface transitioning from high μ to low μ;

FIG. 4B is an explanatory diagram illustrating a state in which the slip ratio of the rear wheels is calculated at the determination position on the road surface transitioning from high μ to low μ;

FIG. 5A is an explanatory diagram illustrating a state in which the slip ratio of the front wheels is calculated at a determination position on a road surface transitioning from low μ to high μ;

FIG. 5B is an explanatory diagram illustrating a state in which the slip ratio of the rear wheels is calculated at the determination position on the road surface transitioning from low μ to high μ;

FIG. 6A is an explanatory diagram illustrating a state in which the slip ratio of the front wheels is calculated at a determination position on a high-μ road;

FIG. 6B is an explanatory diagram illustrating a state in which the slip ratio of the rear wheels is calculated at the determination position on the high-μ road;

FIG. 7 is a conceptual diagram of a slip ratio determination threshold table;

FIG. 8 is a conceptual diagram of a tire chain mounting determination threshold table;

FIG. 9 is a conceptual diagram of a front/rear drive torque distribution ratio map when tire chains are mounted;

FIG. 10A is a flowchart (part 1) illustrating a tire chain mounting determination routine according to an embodiment; and

FIG. 10B is a flowchart (part 2) illustrating the tire chain mounting determination routine.

### DETAILED DESCRIPTION

The technique disclosed in JP-A No. 2019-113940 merely determines whether tire chains are mounted based on the frequency characteristics of vibrations generated in the vehicle body. Therefore, with the technique disclosed in JP-A No. 2019-113940, it is unable to determine whether tire chains are mounted on the front wheels or the rear wheels.

Thus, with the technique disclosed in JP-A No. 2019-113940, it is unable to appropriately modify driving controls of a four-wheel-drive vehicle when tire chains are mounted.

It is desirable to provide a vehicle driving control device capable of automatically determining whether tire chains are mounted on the wheels of a four-wheel-drive vehicle, and appropriately modifying driving controls, such as drive torque distribution control and vehicle dynamics control, for the wheels equipped with the tire chains and those without.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### First Embodiment

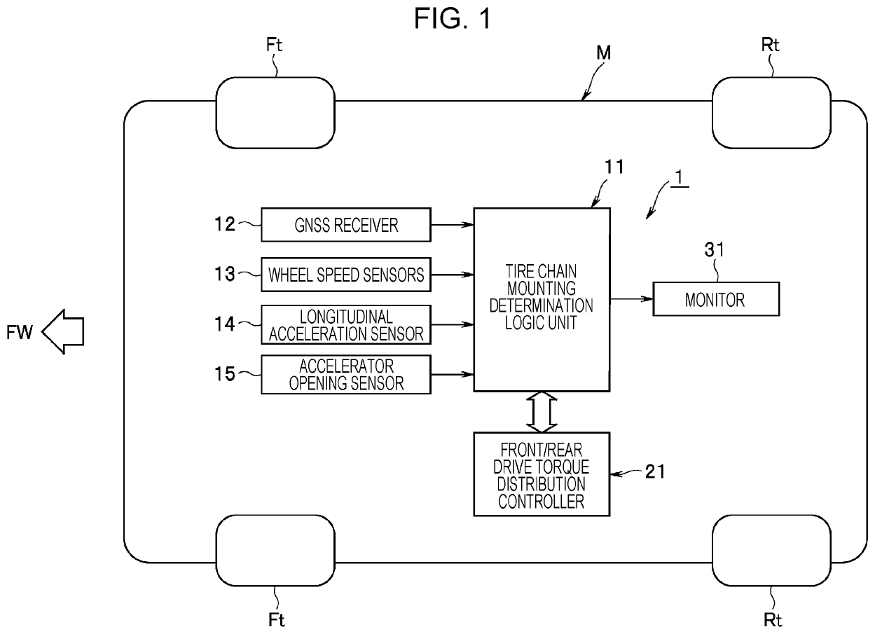

FIGS. 1 to 9 illustrate a first embodiment of the disclosure. In FIG. 1, a vehicle M is a four-wheel-drive vehicle. The center differential of the vehicle M is provided with a front/rear drive torque distribution mechanism. This front/rear drive torque distribution mechanism variably sets the distribution of driving force (torque) from a drive source (such as an engine or electric motor) to front wheels Ft and rear wheels Rt, which are the drive wheels, within a range of 0 to 100 [%]. The front/rear drive torque distribution mechanism operates in accordance with control signals from a front/rear drive torque distribution controller 21, which will be described later.

A drive torque control device 1 mounted on the vehicle M determines whether tire chains are mounted on the front wheels Ft of the vehicle M. If it is determined that tire chains are mounted on the front wheels Ft, the drive torque control device 1 sets the drive torque distribution to the front wheels Ft larger than that to the rear wheels Rt. Note that available tire chains include metal tire chains, non-metal tire chains, and fabric tire chains.

The drive torque control device 1 includes a tire chain mounting determination logic unit 11 and the front/rear drive torque distribution controller 21. The tire chain mounting determination logic unit 11 and the front/rear drive torque distribution controller 21 are coupled so as to enable bidirectional communication. The tire chain mounting determination logic unit 11 and the front/rear drive torque distribution controller 21 are implemented using a microcontroller. The microcontroller includes a central processing unit (CPU), random-access memory (RAM), read-only memory (ROM), rewritable non-volatile memory (such as flash memory or electrically erasable programmable read-only memory (EEPROM)), and peripheral devices. The ROM of the microcomputer stores programs and fixed data necessary for the CPU to perform various processes. Additionally, the RAM is provided as a work area for the CPU and temporarily stores various data used by the CPU. The CPU may also be referred to as a microprocessor (MPU) or processor. Furthermore, in place of the CPU, a graphics processing unit (GPU) or a graph streaming processor (GSP) may be used. Alternatively, a combination of CPU, GPU, and GSP may be selectively employed.

The input side of the tire chain mounting determination logic unit 11 is coupled to a global navigation satellite system (GNSS) receiver 12, wheel speed sensors 13 as a wheel speed detector, a longitudinal acceleration sensor 14, and an accelerator opening sensor 15. Additionally, the output side of the tire chain mounting determination logic unit 11 is coupled to a monitor 31.

The GNSS receiver 12 obtains position information (latitude, longitude, and altitude coordinates) of the vehicle M based on position signals from GNSS satellites. The wheel speed sensors 13 are provided for four wheels, the left and right front wheels Ft and the left and right rear wheels Rt, respectively. The wheel speed sensors 13 detect the wheel speeds of the left and right front wheels Ft and the left and right rear wheels Rt. The longitudinal acceleration sensor 14 detects the longitudinal acceleration of the vehicle M. The accelerator opening sensor 15 detects the amount of depression of the accelerator pedal by a driver who drives the vehicle M. The monitor 31 may be a multi-information display provided in the combination meter or a center information display.

The tire chain mounting determination logic unit 11 calculates the slip ratio of the front wheels Ft (front wheel slip ratio λFt) and the slip ratio of the rear wheels Rt (rear wheel slip ratio λRt) at predetermined intervals while the vehicle M is traveling, and determines whether tire chains are mounted on the front wheels Ft.

The front/rear drive torque distribution controller 21 sets the drive torque distribution ratio between the front wheels Ft and the rear wheels Rt during normal travel to an equal distribution of 50:50 [%]. If the tire chain mounting determination logic unit 11 determines that tire chains are mounted on the front wheels Ft, it calculates the drive torque distribution ratio between the front wheels Ft and the rear wheels Rt. The front/rear drive torque distribution controller 21 operates the front/rear drive torque distribution mechanism according to the drive torque distribution ratio between the front wheels Ft and the rear wheels Rt, calculated by the tire chain mounting determination logic unit 11, thereby variably setting the ratio of the drive torque distribution to the front wheels Ft and the rear wheels Rt.

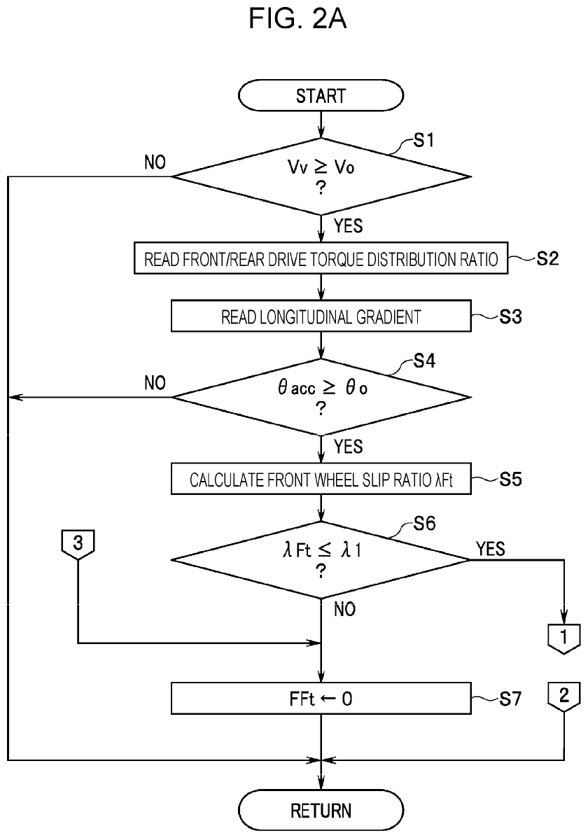

In one example, the tire chain mounting determination logic unit 11 determines whether tire chains are mounted on the front wheels Ft according to a tire chain mounting determination routine illustrated in FIGS. 2A and 2B. This routine is executed at predetermined calculation intervals after the system is started.

First, the tire chain mounting determination logic unit 11 compares the speed of the vehicle M (vehicle speed) Vv with a traveling determination speed Vo to determine whether the vehicle M is currently traveling (step S1). The vehicle speed Vv is obtained, for example, from the average value of the four wheels'speeds detected by the wheel speed sensors 13. The traveling determination speed Vo is a very low vehicle speed of about 1 [Km/h].

If Vv≥Vo (YES), the tire chain mounting determination logic unit 11 determines that the vehicle M is currently traveling, and proceeds to step S2. In contrast, if Vv<Vo (NO), the tire chain mounting determination logic unit 11 exits the routine.

Upon proceeding to step S2, the tire chain mounting determination logic unit 11 reads the current front/rear drive torque distribution ratio set by the front/rear drive torque distribution controller 21. The front/rear drive torque distribution controller 21 controls the distribution of drive torque between the front wheels Ft and the rear wheels Rt within a range of 0 to 100 [%] according to the traveling state of the vehicle M and the road surface conditions. Note that the front/rear drive torque distribution controller 21 sets the drive torque distribution ratio between the front wheels Ft and the rear wheels Rt to an equal distribution of 50:50 [%] during normal travel on a flat road. In contrast, during uphill travel, the ground contact load on the rear wheels Rt increases. Accordingly, the front/rear drive torque distribution controller 21 sets a torque distribution biased toward the rear wheels Rt during uphill travel. Additionally, during downhill travel, the ground contact load on the front wheels Ft increases. Accordingly, the front/rear drive torque distribution controller 21 sets a torque distribution biased toward the front wheels Ft during downhill travel. Note that, during normal travel on a flat road, the drive torque distribution ratio between the front wheels Ft and the rear wheels Rt may be set to an unequal distribution, such as 60:40 [%].

Next, the tire chain mounting determination logic unit 11 reads the longitudinal gradient (uphill or downhill) of the road surface (step S3). The longitudinal gradient is calculated by the front/rear drive torque distribution controller 21. The front/rear drive torque distribution controller 21 calculates the longitudinal gradient, for example, by subtracting the vehicle body acceleration from the longitudinal acceleration. The longitudinal acceleration is detected by the longitudinal acceleration sensor 14. Additionally, the front/rear drive torque distribution controller 21 calculates the vehicle body acceleration by computing the vehicle body displacement amount per unit time based on the position information of the vehicle M obtained from the GNSS receiver 12, and calculating the second derivative of this vehicle body displacement amount.

Subsequently, the tire chain mounting determination logic unit 11 compares an accelerator opening degree θacc detected by the accelerator opening sensor 15 with an accelerator depression determination threshold θo (step S4). This accelerator depression determination threshold θo is a value used to determine whether the driver has depressed the accelerator pedal. It is necessary to detect the slip ratios λFt and λRt of the front and rear wheels Ft and Rt while drive torque has been transmitted to the front and rear wheels Ft and Rt.

If θacc≥θo (YES), the tire chain mounting determination logic unit 11 determines that the driver has depressed the accelerator pedal, and calculates the front wheel slip ratio λFt (step S5). If θacc<θo (NO), the tire chain mounting determination logic unit 11 determines that the accelerator pedal is in a released state, and exits the routine. The processing in step S5 corresponds to a front wheel slip ratio calculator of the disclosure.

The tire chain mounting determination logic unit 11 calculates the front wheel slip ratio λFt based, for example, on the vehicle body speed and the wheel speeds of the left and right front wheels Ft (average wheel speed) detected by the wheel speed sensors 13, using the following equation (1):

$$λ Ft = ( ( vehicle body speed - wheel speed ) / wheel speed ) \times 100 [ \% ] \qquad ( 1 )$$

The tire chain mounting determination logic unit 11 obtains the vehicle body speed, for example, from the vehicle body displacement amount per unit time based on the position information of the vehicle M obtained from the GNSS receiver 12. Accordingly, the tire chain mounting determination logic unit 11 is equipped with a function as a vehicle body speed detector.

Next, the tire chain mounting determination logic unit 11 compares the front wheel slip ratio λFt with a slip ratio determination threshold λ1 (step S6). This slip ratio determination threshold λ1 is a value used to determine whether the front wheels Ft are slipping. When tire chains are mounted on the front wheels Ft, it can be estimated that the front wheel slip ratio λFt will be small.

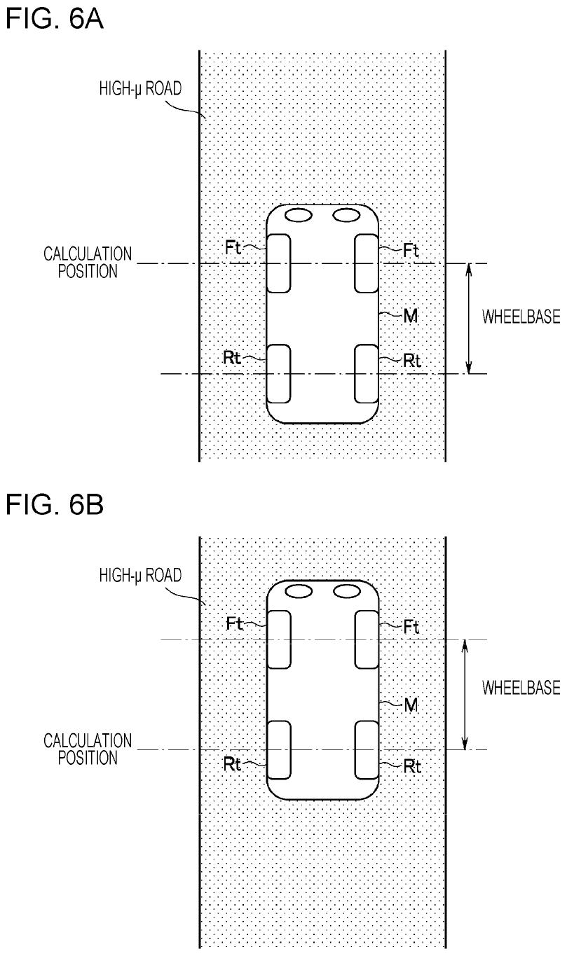

The tire chain mounting determination logic unit 11 sets the slip ratio determination threshold λ1 with reference to a slip ratio determination threshold table indicated in FIG. 7. This slip ratio determination threshold table stores, in advance based on experiments or the like, the relationship between the longitudinal gradient of the road surface, the drive torque distribution to the front wheels Ft, and the slip ratio determination threshold λ1. In the slip ratio determination threshold table, higher values of the slip ratio determination threshold λ1 are set as the longitudinal gradient of the road surface becomes greater, or as the drive torque distribution to the front wheels Ft becomes larger.

For example, in uphill travel, when the longitudinal gradient of the road surface is large, the proportion of ground contact load distributed to the front wheels Ft decreases. Under such conditions, the front wheels Ft are more likely to slip, and therefore the slip ratio determination threshold λ1 is set to a high value. Likewise, during travel on a road surface with a small gradient such as a flat road, if the drive torque distribution to the front wheels Ft is large, slipping is also likely to occur. Therefore, in such cases, the slip ratio determination threshold λ1 is also set to a high value. This makes it possible to determine with high accuracy whether the front wheels Ft are slipping, even during uphill travel and in cases where the drive torque distribution to the front wheels Ft is large.

Then, if λFt>λ1 (NO), the tire chain mounting determination logic unit 11 determines that the front wheels Ft are slipping, and proceeds to step S7. Upon proceeding to step S7, the tire chain mounting determination logic unit 11 determines that no tire chains are mounted, clears a front wheel slip determination flag FFt (FFt0 ←0), and exits the routine. In contrast, if λFt ≤λ1 (YES), the tire chain mounting determination logic unit 11 determines that the front wheels Ft are not slipping, and branches to step S8.

As factors contributing to a low front wheel slip ratio λFt, it can be considered that either tire chains are mounted on the front wheels Ft, or the vehicle M is traveling on a high-μ road. The tire chain mounting determination logic unit 11 determines whether tire chains are mounted on the front wheels Ft in steps S8 to S13.

First, the tire chain mounting determination logic unit 11 determines whether the vehicle M has moved forward by a distance corresponding to its wheelbase (step S8). Whether the vehicle M has moved forward by the distance corresponding to its wheelbase can be determined, for example, by calculating the travel time for the distance corresponding to the wheelbase based on the vehicle speed Vv and the wheelbase, and checking whether the elapsed time has reached the travel time. Alternatively, the current position coordinates of the vehicle M are obtained from the GNSS receiver 12, and it is determined whether the vehicle M has moved to a position obtained by adding the wheelbase to the position coordinates.

When it is determined that the vehicle M has not moved forward by the distance corresponding to its wheelbase (NO), the tire chain mounting determination logic unit 11 enters standby. Then, when it is determined that the vehicle M has moved forward by the distance corresponding to its wheelbase (YES), the tire chain mounting determination logic unit 11 calculates the rear wheel slip ratio λRt (step S9). Note that the processing in steps S8 and S9 corresponds to a rear wheel slip ratio calculator of the disclosure.

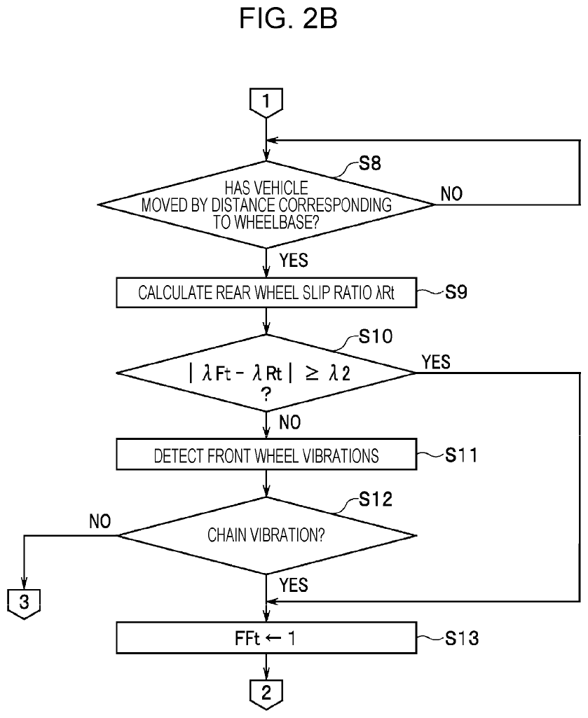

As a result, substantially, the position where the front wheel slip ratio λFt is calculated, as illustrated in FIGS. 3A, 4A, 5A, and 6A, and the position where the rear wheel slip ratio λRt is calculated, as illustrated in FIGS. 3B, 4B, 5B, and 6B, become identical. Accordingly, the front wheel slip ratio λFt and the rear wheel slip ratio λRt can be calculated under the same road surface conditions.

The tire chain mounting determination logic unit 11 calculates the rear wheel slip ratio λRt, for example, based on the average wheel speed of the left and right rear wheels Rt detected by the wheel speed sensors 13 and the vehicle body speed, using the following equation (2):

$$λ Rt = ( ( vehicle body speed - average wheel speed ) / average wheel speed ) \times 100 [ \% ] \qquad ( 2 )$$

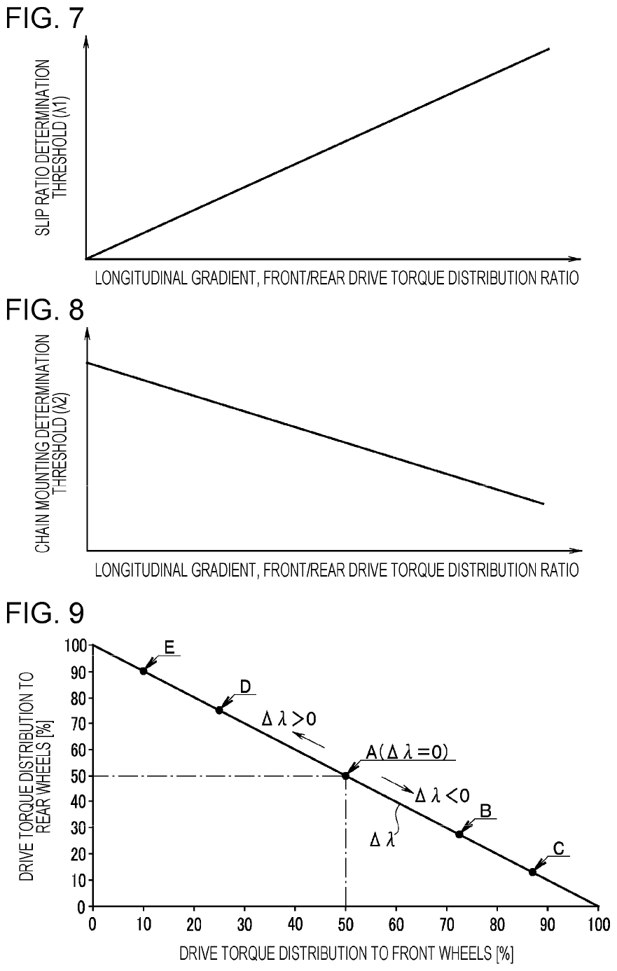

Thereafter, the tire chain mounting determination logic unit 11 compares the absolute value of the difference between the front wheel slip ratio λFt and the rear wheel slip ratio λRt (|λFt−λRt|) with a tire chain mounting determination threshold λ2, which serves as a first threshold (step S10). The tire chain mounting determination logic unit 11 sets the tire chain mounting determination threshold λ2 with reference to a tire chain mounting determination threshold table indicated in FIG. 8. This tire chain mounting determination threshold table stores, in advance based on experiments or the like, the relationship between the longitudinal gradient of the road surface, the front/rear drive torque distribution ratio, and the slip ratio difference threshold λ2. In the tire chain mounting determination threshold table, lower values of the tire chain mounting determination threshold λ2 are set as the longitudinal gradient of the road surface becomes larger and as the drive torque distribution to the front wheels Ft becomes larger.

For example, in uphill travel, when the longitudinal gradient of the road surface is large, the proportion of ground contact load distributed to the rear wheels Rt increases, making the rear wheels Rt less likely to slip. Therefore, under such conditions, it can be estimated that the difference between the slip ratios λFt and λRt of the front and rear wheels will be small. Accordingly, the tire chain mounting determination threshold λ2 is set to a low value. Likewise, during travel on a road surface with a small gradient such as a flat road, if the drive torque distribution to the front wheels Ft is large, the front wheels Ft are more likely to slip. Therefore, in such cases as well, the tire chain mounting determination threshold λ2 is set to a low value. This makes it possible to determine with high accuracy whether tire chains are mounted on the front wheels Ft.

Then, if |λFt−λRt|≥λ2 (YES), the tire chain mounting determination logic unit 11 determines that the front wheels Ft are not slipping, but the rear wheels Rt are slipping, and jumps to step S13.

The state of |λFt−λRt|≥λ2 can occur, for example, in the following cases 1 and 2.

### Case 1

As illustrated in FIGS. 3A and 3B, even if the front and rear wheels Ft and Rt are traveling on a uniform, low-μroad, tire chains are mounted on the front wheels Ft, and slipping of the rear wheels Rt is detected at the calculation position. Therefore, it can be estimated that tire chains are mounted on the front wheels Ft.

### Case 2

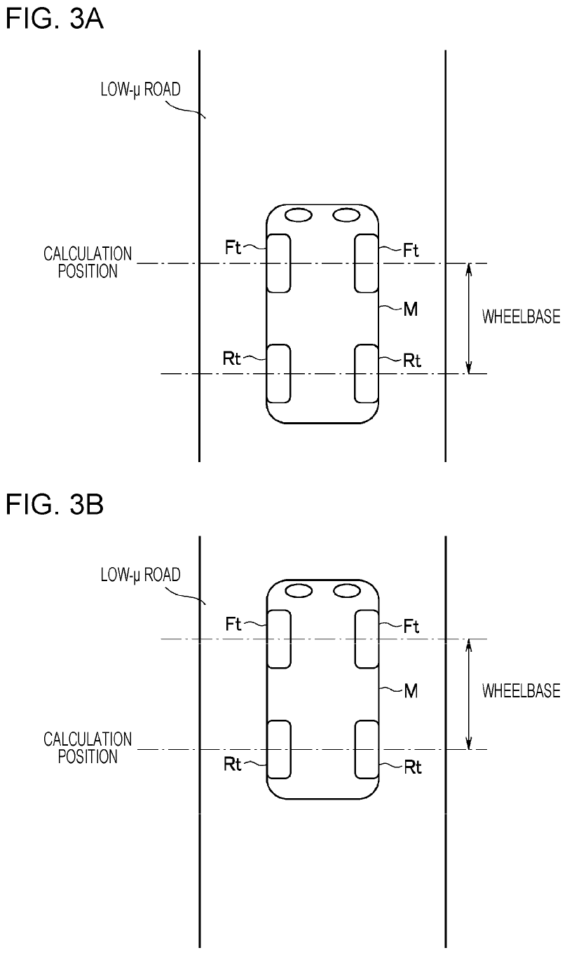

As illustrated in FIGS. 4A and 4B, the position where the front wheel slip ratio λFt is calculated is located on a low-μ road, and at that time, the rear wheels Rt are on a high-μ road. When the rear wheels Rt reach the calculation position, they are on the low-μ road and therefore slip. In such a case, it can be estimated that tire chains are mounted on the front wheels Ft.

If |λFt−λRt|<λ2 (NO), the tire chain mounting determination logic unit 11 determines that neither the front wheels Ft nor the rear wheels Rt are slipping, and proceeds to step S11.

The state of |λFt−λRt|<λ2 can occur, for example, in cases 3 and 4 below.

### Case 3

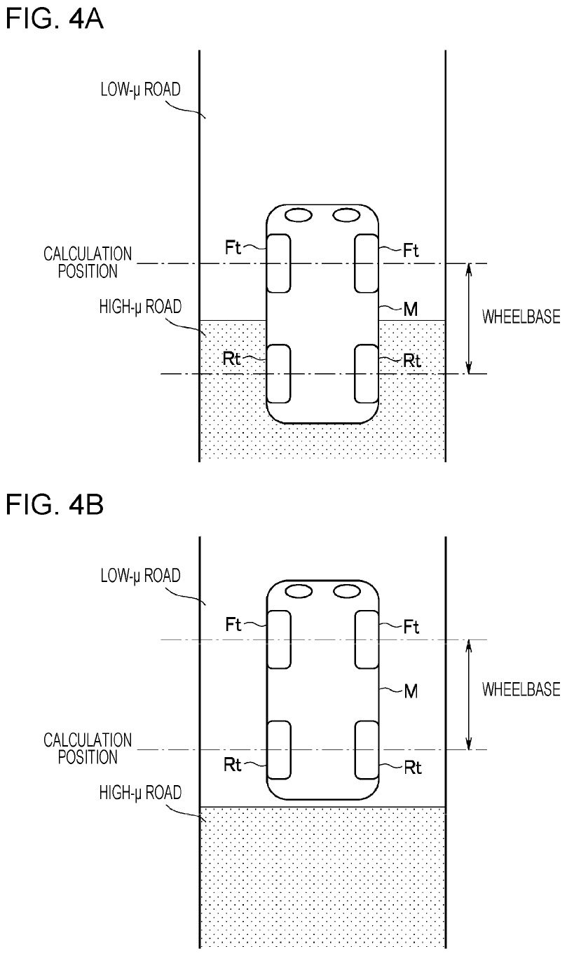

As illustrated in FIGS. 5A and 5B, the position where the front wheel slip ratio λFt is calculated is located on a high-μ road, and at that time, the rear wheels Rt are on a low-μ road. When the rear wheels Rt reach the calculation position, they are on the high-μ road, and therefore no slip is detected. Accordingly, it is not possible to determine whether tire chains are mounted on the front wheels Ft.

### Case 4

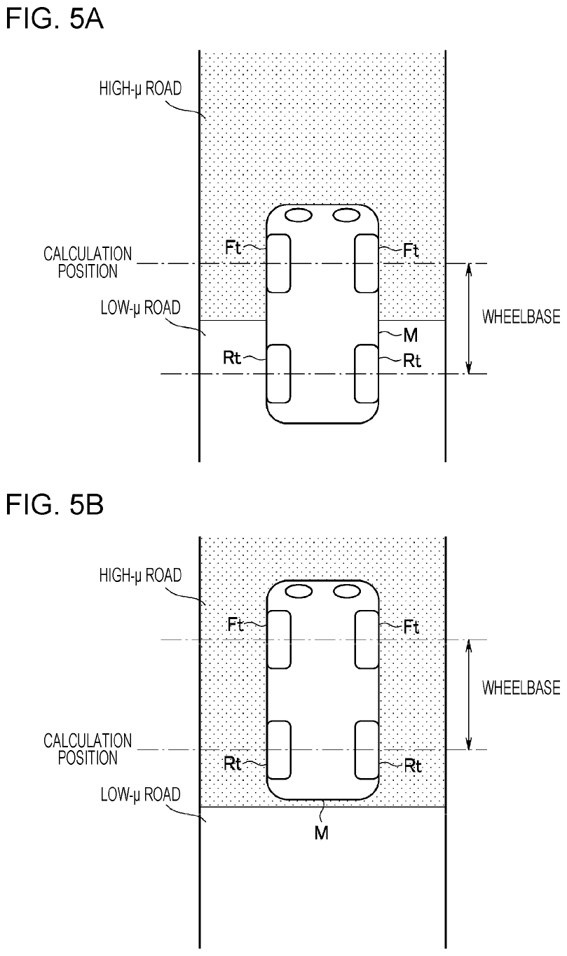

As illustrated in FIGS. 6A and 6B, both the front and rear wheels Ft and Rt are traveling on a uniform, high-μroad, and no slip is detected even when the rear wheels Rt reach the calculation position. Accordingly, it is not possible to determine whether tire chains are mounted on the front wheels Ft.

In steps S11 and S12, the tire chain mounting determination logic unit 11 determines whether tire chains are mounted on the front wheels Ft.

The tire chain mounting determination logic unit 11 detects vibrations of the left and right front wheels Ft, respectively (step S11). Various means for detecting the vibrations of the front wheels Ft are conceivable. In the present embodiment, changes in acceleration (jerk) obtained from the wheel speeds of the left and right front wheels Ft detected by the wheel speed sensors 13 are detected as the vibrations of the front wheels Ft.

Next, the tire chain mounting determination logic unit 11 determines whether tire chains are mounted on the front wheels Ft based on the vibrations (jerk) of the left and right front wheels Ft (step S12). The ground contact part of each tire chain is formed by repetition of a uniform unit pattern. The tire chain mounting determination logic unit 11 analyzes the vibration patterns of the left and right front wheels Ft, respectively, and determines whether tire chains are mounted on the front wheels Ft. When the vibration pattern of the front wheels Ft is repeated periodically, the tire chain mounting determination logic unit 11 determines that the vibration is chain vibration.

When it is determined that the vibration pattern of the front wheels Ft is chain vibration (step S12: YES), the tire chain mounting determination logic unit 11 proceeds to step S13. When it is determined that the vibration pattern of the front wheels Ft is not chain vibration (step S12: NO), the tire chain mounting determination logic unit 11 returns to step S7.

Upon proceeding to step S13, the tire chain mounting determination logic unit 11 sets the front wheel slip determination flag FFt (FFt←1), and exits the routine. When the tire chain mounting determination logic unit 11 determines that tire chains are mounted on the front wheels Ft, it may also display this information as an image or other similar information on the monitor 31. Note that the processing in steps S6 to S13 corresponds to a tire chain mounting determiner of the disclosure.

The front wheel slip determination flag FFt set by the tire chain mounting determination logic unit 11 is read by the front/rear drive torque distribution controller 21. The front/rear drive torque distribution controller 21 reads the value of the front wheel slip determination flag FFt. If FFt=0, the front/rear drive torque distribution controller 21 variably sets the front/rear drive torque distribution ratio according to the state of the vehicle M, starting from an initial front/rear drive torque distribution ratio (for example, front wheels Ft:rear wheels Rt=50:50 [%]).

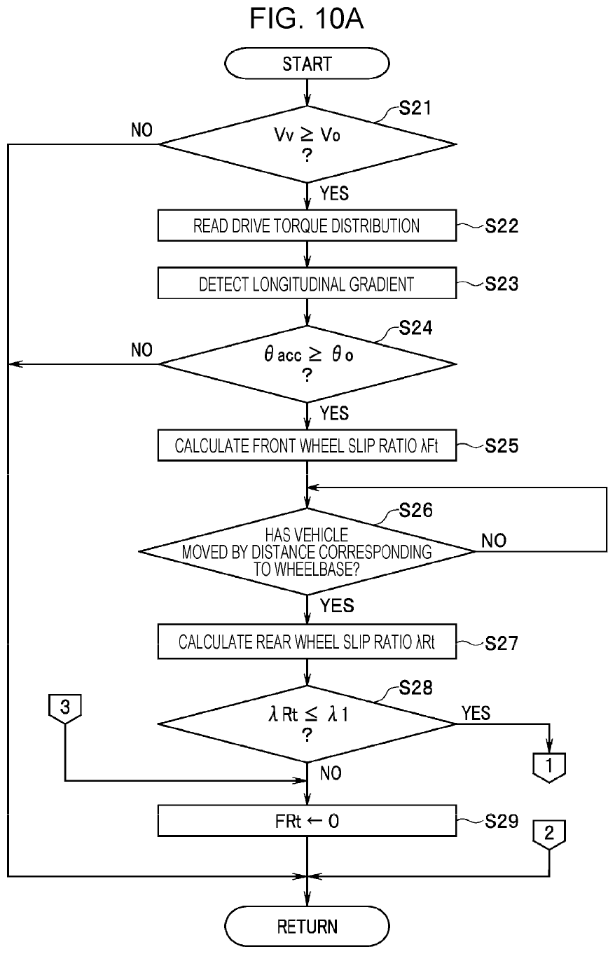

In contrast, when the value of the front wheel slip determination flag is FFt=1, the front/rear drive torque distribution controller 21 reads the front wheel slip ratio λFt and the rear wheel slip ratio λRt calculated by the tire chain mounting determination logic unit 11. Then, the front/rear drive torque distribution controller 21 refers to a front/rear drive torque distribution ratio map indicated in FIG. 9. The front/rear drive torque distribution ratio map indicated in FIG. 9 stores, in advance based on experimental results or the like, the relationship between the difference Δλ (λFt−λRt) between the front wheel slip ratio λFt and the rear wheel slip ratio λRt, the drive torque distribution to the front wheels, and the drive torque distribution to the rear wheels.

In the front/rear drive torque distribution ratio map, the difference Δλ=0 is set as a central reference value A (Ft:Rt=50:50 [%] in the figure). In the front/rear drive torque distribution ratio map, when Δλ<0 (λFt<λRt), the drive torque distribution to the front wheels becomes higher as Δλ increases from the central reference value A. Conversely, in the front/rear drive torque distribution ratio map, when Δλ>0 (λFt>λRt), the drive torque distribution to the rear wheels becomes higher as Δλ increases from the central reference value A.

Accordingly, when tire chains are mounted on the front wheels Ft in the case of FFt=1, the front/rear drive torque distribution controller 21 sets the front/rear drive torque distribution ratio so as to bias the drive torque toward the front wheels Ft. For example, compared to the difference Δλ (difference B) obtained when winter tires are mounted on all four wheels and tire chains are mounted on the front wheels Ft, the difference Δλ (difference C) obtained when summer tires are mounted on all four wheels and tire chains are mounted on the front wheels Ft is inevitably such that the drive torque distribution to the front wheels Ft becomes higher.

Thus, in the present embodiment, the tire chain mounting determination logic unit 11 automatically determines whether tire chains are mounted on the front wheels Ft based on the difference between the front wheel slip ratio λFt and the rear wheel slip ratio λRt. As a result, the front/rear drive torque distribution controller 21 can appropriately control the drive torque distribution to the front and rear wheels Ft and Rt based on the determination result obtained by the tire chain mounting determination logic unit 11.

Furthermore, since the front wheel slip ratio λFt and the rear wheel slip ratio λRt are calculated under the same road surface conditions, the slip ratios λFt and λRt can be compared with high accuracy.

### Second Embodiment

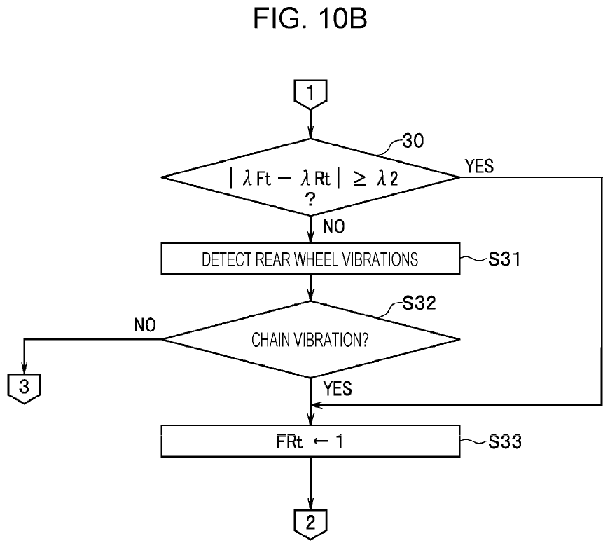

FIGS. 10A and 10B illustrate a second embodiment of the disclosure. In the first embodiment, it is determined whether tire chains are mounted on the front wheels Ft; in a second embodiment, it is determined whether tire chains are mounted on the rear wheels Rt.

Whether tire chains are mounted on the rear wheels Rt is determined by the tire chain mounting determination logic unit 11 illustrated in FIG. 1. In one example, the tire chain mounting determination logic unit 11 determines whether tire chains are mounted on the rear wheels Rt according to a tire chain mounting determination routine illustrated in FIGS. 10A and 10B. This routine is executed at predetermined calculation intervals after the system is started.

In steps S21 to S25, the tire chain mounting determination logic unit 11 performs the same processing as steps S1 to S5 in FIG. 2A. Next, the tire chain mounting determination logic unit 11 determines whether the vehicle M has moved forward by a distance corresponding to its wheelbase (step S26). Since whether the vehicle M has moved forward by the distance corresponding to its wheelbase is determined by the same processing as step S8 in FIG. 2B, its description is omitted.

When it is determined that the vehicle M has not moved forward by the distance corresponding to its wheelbase (NO), the tire chain mounting determination logic unit 11 enters standby. Then, when it is determined that the vehicle M has moved forward by the distance corresponding to its wheelbase (YES), the tire chain mounting determination logic unit 11 calculates the rear wheel slip ratio λRt using equation (2) mentioned above (step S27). Note that the processing in steps S26 and S27 corresponds to the rear wheel slip ratio calculator of the disclosure.

As a result, the position where the front wheel slip ratio λFt is calculated, as illustrated in FIGS. 3A, 4A, 5A, and 6A, and the position where the rear wheel slip ratio λRt is calculated, as illustrated in FIGS. 3B, 4B, 5B, and 6B, become identical. Therefore, the front wheel slip ratio λFt and the rear wheel slip ratio λRt can be calculated under the same road surface conditions.

Next, the tire chain mounting determination logic unit 11 compares the rear wheel slip ratio λRt with the slip ratio determination threshold λ1 (step S28). This slip ratio determination threshold λ1 is a value used to determine whether the rear wheels Rt are slipping. When tire chains are mounted on the rear wheels Rt, it can be estimated that the rear wheel slip ratio λRt will be small.

The tire chain mounting determination logic unit 11 sets the slip ratio determination threshold λ1 with reference to a slip ratio determination threshold table indicated in FIG. 7. This slip ratio determination threshold table stores, in advance based on experiments or the like, the relationship between the longitudinal gradient of the road surface, the drive torque distribution to the rear wheels Rt, and the slip ratio determination threshold λ1. In the slip ratio determination threshold table, higher values of the slip ratio determination threshold λ1 are set as the longitudinal gradient of the road surface becomes smaller, and as the drive torque distribution to the rear wheels Rt becomes larger.

For example, in uphill travel, as the longitudinal gradient of the road surface decreases, the proportion of ground contact load distributed to the rear wheels Rt gradually decreases, while the ground contact load distributed to the front wheels Ft increases relatively. Accordingly, the front wheels Ft become less likely to slip. Likewise, during travel on a road surface with a small gradient such as a flat road, if the drive torque distribution to the front wheels Ft is small, the front wheels Ft are less likely to slip.

In the slip ratio determination threshold table, higher values of the slip ratio determination threshold λ1 are set as the longitudinal gradient of the road surface becomes smaller, and as the drive torque distribution to the rear wheels Rt becomes larger. This makes it possible to determine with high accuracy whether the rear wheels Rt are slipping, even in cases where the gradient of the road surface is small and the drive torque distribution to the rear wheels Rt is large.

Then, if λRt>λ1 (step S28: NO), the tire chain mounting determination logic unit 11 determines that the rear wheels Rt are slipping, and proceeds to step S29. Upon proceeding to step S29, the tire chain mounting determination logic unit 11 determines that no tire chains are mounted, clears a rear wheel slip determination flag FRt (FRt0←0), and exits the routine. In contrast, if λRt≤λ1 (step S28: YES), the tire chain mounting determination logic unit 11 determines that the rear wheels Rt are not slipping, and branches to step S30.

As factors contributing to a low rear wheel slip ratio λRt, it can be considered that either tire chains are mounted on the rear wheels Rt, or the vehicle M is traveling on a high-μ road. The tire chain mounting determination logic unit 11 determines whether tire chains are mounted on the rear wheels Rt in steps S30 to S33.

First, the tire chain mounting determination logic unit 11 compares the absolute value of the difference between the front wheel slip ratio λFt and the rear wheel slip ratio λRt (|λFt−λRt|) with the tire chain mounting determination threshold λ2 (step S30). The tire chain mounting determination logic unit 11 sets the tire chain mounting determination threshold λ2 with reference to the aforementioned tire chain mounting determination threshold table indicated in FIG. 8. In the tire chain mounting determination threshold table, lower values of the tire chain mounting determination threshold λ2 are set as the longitudinal gradient of the road surface becomes smaller and as the drive torque distribution to the rear wheels Rt becomes larger.

For example, when the longitudinal gradient of the road surface is small, the proportion of ground contact load distributed to the rear wheels Rt decreases compared to when the longitudinal gradient is large, whereby the grip force of the front wheels Ft relatively increases, making the front wheels Ft less likely to slip. Under such conditions, it can be estimated that the difference between the slip ratios λFt and λRt of the front and rear wheels will be small, and accordingly the tire chain mounting determination threshold λ2 is set to a low value. Likewise, during travel on a flat road, if the drive torque distribution to the front wheels Ft is large, the front wheels Ft are less likely to slip. Therefore, in such cases as well, the tire chain mounting determination threshold λ2 is set to a low value. This makes it possible to determine with high accuracy whether tire chains are mounted on the rear wheels Rt.

Then, if |λFt−λRt|≥λ2 (YES), the tire chain mounting determination logic unit 11 determines that the rear wheels Rt are not slipping, but the front wheels Ft are slipping, and jumps to step S33. When the tire chain mounting determination logic unit 11 determines that tire chains are mounted on the rear wheels Rt, it may also display this information as an image or other similar information on the monitor 31. Note that the processing in steps S28 to S33 corresponds to the tire chain mounting determiner of the disclosure.

The state of |λFt−λRt|≥λ2 can occur, for example, in the following cases 1 and 2.

### Case 1

As illustrated in FIGS. 3A and 3B, even if the front and rear wheels Ft and Rt are traveling on a uniform, low-μ road, tire chains are mounted on the rear wheels Rt, and slipping of the front wheels Ft is detected at the calculation position. Therefore, it can be estimated that tire chains are mounted on the rear wheels Rt.

### Case 2

As illustrated in FIGS. 4A and 4B, the position where the front wheel slip ratio λFt is calculated is located on a low-μ road, and thus, the front wheels Ft are slipping. When the rear wheels Rt reach the calculation position, no slip is detected. Therefore, it can be estimated that tire chains are mounted on the rear wheels Rt.

If |λFt−λRt|<λ2 (NO), the tire chain mounting determination logic unit 11 determines that neither the front wheels Ft nor the rear wheels Rt are slipping, and proceeds to step S11.

The state of |λFt−λRt|<λ2 can occur, for example, in cases 3 and 4 below.

### Case 3

As illustrated in FIGS. 5A and 5B, the position where the front wheel slip ratio λFt is calculated is located on a high-μ road, and at that time, the rear wheels Rt are on a low-μ road. When the rear wheels Rt reach the calculation position, they are on the high-μ road, and therefore no slip is detected. Accordingly, it is not possible to determine whether tire chains are mounted on the rear wheels Rt.

### Case 4

As illustrated in FIGS. 6A and 6B, both the front and rear wheels Ft and Rt are traveling on a uniform, high-μ road, and no slip is detected even when the rear wheels Rt reach the calculation position. Accordingly, it is not possible to determine whether tire chains are mounted on the rear wheels Rt.

In steps S31 and S32, the tire chain mounting determination logic unit 11 determines whether tire chains are mounted on the rear wheels Rt.

The tire chain mounting determination logic unit 11 detects vibrations of the left and right rear wheels Rt, respectively (step S31). The tire chain mounting determination logic unit 11 calculates the second derivative of the wheel speeds of the left and right rear wheels Rt, detected by the wheel speed sensors 13 as a wheel speed detector, to obtain the jerk for each wheel. Then, the tire chain mounting determination logic unit 11 sets this jerk as the vibration of the rear wheels Rt.

Next, the tire chain mounting determination logic unit 11 determines whether tire chains are mounted on the rear wheels Rt based on the vibrations (jerk) of the left and right rear wheels Rt (step S32). The tire chain mounting determination logic unit 11 analyzes the vibration patterns of the left and right rear wheels Rt, respectively, and determines whether tire chains are mounted on the rear wheels Rt. When the vibration pattern of the rear wheels Rt is repeated periodically, the tire chain mounting determination logic unit 11 determines that the vibration is chain vibration.

When it is determined that the vibration pattern of the rear wheels Rt is chain vibration (step S32: YES), the tire chain mounting determination logic unit 11 proceeds to step S33. When it is determined that the vibration pattern of the rear wheels Rt is not chain vibration (step S32: NO), the tire chain mounting determination logic unit 11 returns to step S29.

Upon proceeding to step S33, the tire chain mounting determination logic unit 11 sets the rear wheel slip determination flag FRt (FRt←1), and exits the routine.

The rear wheel slip determination flag FRt set by the tire chain mounting determination logic unit 11 is read by the front/rear drive torque distribution controller 21. The front/rear drive torque distribution controller 21 reads the value of the rear wheel slip determination flag FRt. If FRt=0, the front/rear drive torque distribution controller 21 variably sets the distribution ratio of the front/rear drive torque according to the state of the vehicle M, starting from an initial front/rear drive torque distribution ratio (for example, front wheels Ft:rear wheels Rt=50:50 [%]).

In contrast, when the value of the rear wheel slip determination flag is FRt=1, the front/rear drive torque distribution controller 21 reads the front wheel slip ratio λFt and the rear wheel slip ratio λRt calculated by the tire chain mounting determination logic unit 11. Then, the front/rear drive torque distribution controller 21 refers to the aforementioned front/rear drive torque distribution ratio map indicated in FIG. 9.

When tire chains are mounted on the rear wheels Rt in the case of FRt=1, the front/rear drive torque distribution controller 21 sets the front/rear drive torque distribution ratio so as to bias the drive torque toward the rear wheels Rt. For example, compared to the difference Δλ (difference D) obtained when winter tires are mounted on all four wheels and tire chains are mounted on the rear wheels Rt, the difference Δλ (difference E) obtained when summer tires are mounted on all four wheels and tire chains are mounted on the rear wheels Rt is inevitably such that the drive torque distribution to the rear wheels Rt becomes higher.

As above, in the present embodiment, the tire chain mounting determination logic unit 11 is configured to automatically determine whether tire chains are mounted on the rear wheels Rt based on the difference between the front wheel slip ratio λFt and the rear wheel slip ratio λRt. As a result, the front/rear drive torque distribution controller 21 can appropriately control the drive torque distribution ratio between the front and rear wheels Ft and Rt based on the determination result obtained by the tire chain mounting determination logic unit 11.

Note that the disclosure is not limited to the above-described embodiments. For example, by combining the first embodiment and the second embodiment, it is possible to determine whether tire chains are mounted on all four wheels of the vehicle M. When it is determined that tire chains are mounted on all four wheels, the front/rear drive torque distribution controller 21 may fix the drive torque distribution ratio between the front and rear wheels Ft and Rt to the initial value (for example, 50:50 [%]).

Additionally, the values of the slip determination flags FFt and FRt set by the tire chain mounting determination logic unit 11 may be read during other drive controls, such as vehicle dynamics control, to perform control corresponding to the tire chain mounting. Furthermore, as the front/rear drive torque distribution mechanism, for example, a torque vectoring mechanism that varies torque between the front and rear wheels may be employed.

According to the disclosure, the front wheel slip ratio is calculated based on the wheel speeds of the front wheels and the vehicle body speed, and the rear wheel slip ratio is calculated based on the wheel speeds of the rear wheels and the vehicle body speed at the same road surface position as that at which the front wheel slip ratio has been calculated. When the difference between the front wheel slip ratio and the rear wheel slip ratio is greater than or equal to a first threshold, it is determined that tire chains are mounted on the wheels, front or rear, having a lower slip ratio. Accordingly, whether tire chains are mounted on the wheels of a four-wheel-drive vehicle can be automatically determined, and drive controls such as drive torque distribution control and vehicle dynamics control can be appropriately performed for wheels with and without tire chains.

The drive torque control device 1 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the drive torque control device 1 including the tire chain mounting determination logic unit 11 and the front/rear drive torque distribution controller 21. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle driving control device comprising:
a wheel speed detector configured to detect respective wheel speeds of front wheels and rear wheels of a four-wheel-drive vehicle; and
a tire chain mounting determination logic unit,
the tire chain mounting determination logic unit comprising:
a vehicle body speed detector configured to detect a vehicle body speed of the four-wheel-drive vehicle;
a front wheel slip ratio calculator configured to calculate a front wheel slip ratio based on the wheel speeds of the front wheels detected by the wheel speed detector and the vehicle body speed detected by the vehicle body speed detector;
a rear wheel slip ratio calculator configured to calculate a rear wheel slip ratio based on the wheel speeds of the rear wheels detected by the wheel speed detector and the vehicle body speed detected by the vehicle body speed detector, at a same road surface position as a road surface position at which the front wheel slip ratio has been calculated; and
a tire chain mounting determiner configured to determine that tire chains are mounted on the front wheels or the rear wheels which have a lower slip ratio, when a difference between the front wheel slip ratio calculated by the front wheel slip ratio calculator and the rear wheel slip ratio calculated by the rear wheel slip ratio calculator is greater than or equal to a first threshold.

2. The vehicle driving control device according to claim 1, further comprising:
a front/rear drive torque distribution controller configured to control distribution of drive torque to the front wheels and the rear wheels,
wherein the front/rear drive torque distribution controller is configured to bias the distribution of drive torque toward the front wheels or the rear wheels determined by the tire chain mounting determiner to have the tire chains mounted.

3. The vehicle driving control device according to claim 1, wherein:
the tire chain mounting determiner is configured to determine that tire chains are mounted on the front wheels or the rear wheels when the front wheel slip ratio calculated by the front wheel slip ratio calculator is less than or equal to a second threshold or the rear wheel slip ratio calculated by the rear wheel slip ratio calculator is less than or equal to the second threshold, and an absolute value of a difference between the front wheel slip ratio and the rear wheel slip ratio is greater than or equal to the first threshold.

4. The vehicle driving control device according to claim 1, wherein:
the tire chain mounting determiner is configured to determine that tire chains are mounted on the front wheels when the front wheel slip ratio calculated by the front wheel slip ratio calculator is less than or equal to a second threshold, an absolute value of a difference between the front wheel slip ratio and the rear wheel slip ratio calculated by the rear wheel slip ratio calculator is less than the first threshold, and it is determined that vibration of the front wheels is chain vibration.

5. The vehicle driving control device according to claim 1, wherein:
the tire chain mounting determiner is configured to determine that tire chains are mounted on the rear wheels when the rear wheel slip ratio calculated by the rear wheel slip ratio calculator is less than or equal to a second threshold, an absolute value of a difference between the rear wheel slip ratio and the front wheel slip ratio calculated by the front wheel slip ratio calculator is less than the first threshold, and it is determined that vibration of the rear wheels is chain vibration.

6. A vehicle driving control device comprising:
a wheel speed detector comprising a sensor and configured to detect wheel respective speeds of front wheels and rear wheels of a four-wheel-drive vehicle; and
circuitry configured to
detect a vehicle body speed of the four-wheel-drive vehicle;
calculate a front wheel slip ratio based on the wheel speeds of the front wheels detected by the wheel speed detector and the vehicle body speed;
calculate a rear wheel slip ratio based on the wheel speeds of the rear wheels detected by the wheel speed detector and the vehicle body speed, at a same road surface position as a road surface position at which the front wheel slip ratio has been calculated; and
determine that tire chains are mounted on the front wheels or the rear wheels which have a lower slip ratio when a difference between the front wheel slip ratio calculated by the front wheel slip ratio calculator and the rear wheel slip ratio calculated by the rear wheel slip ratio calculator is greater than or equal to a first threshold.
